(19) United States
(12) Patent Application Publication
(10) Pub. No.: US 2006/0067327 A1
(43) Pub. Date: Mar. 30, 2006

(54) Information distribution system, method and network devices

(76) Inventors: Behrouz Poustchi, Ottawa (CA); James Andrew Stelzig, Gatineau (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/952,905

(22) Filed: Sep. 30, 2004

(51) Int. Cl. H04L 12/56

(52) U.S. Cl. 370/395.5; 370/396

(57) ABSTRACT

A method involves, at a network device, receiving information; storing the information; and sending the information to at least one other network. The information is adapted for use by the network device and the at least one other network device in providing local facilitating related functionality. In some implementations the method is applied at each of a plurality of network devices in a system resulting in the information being distributed to the network devices. In some implementations, distribution of the information allows the network devices to provide the call facilitating functionality locally without the use of central processing equipment. In some implementations access to the information being distributed and/or other information is restricted to avoid conflicts.

### FIELD OF THE INVENTION

The invention relates to an information distribution system, method, and network devices.

### BACKGROUND OF THE INVENTION

Some modern communications solutions are based on VOIP (Voice-over IP (Internet Protocol)) technology, which is the transmission of calls over a data network based on the IP. The communication is in the form of packet data and there is no fixed connection as there would be in the case of switched networks. The communication can be text, voice, graphics or video. In order to simplify IP communication problems, standards have been developed and adopted in the industry. Examples of such standards are H.323 (Packet based communication systems) and SIP (Session Initiation Protocol). These standards are followed when designing new hardware and software. The SIP standard covers the technical requirements to set-up, modify and tear down multimedia sessions over the Internet. A multimedia communication session between two endpoints will be referred to as a call.

Communication solutions, whether they be switch based or packet based, are defined and designed for a specific number of users and call processing capacity, generally defined by the number of ports (telephone terminations) and the amount of processing available on a central processing equipment that provides routing and call processing functionality for telephones sets. Hence, equipment vendors generally develop and market versions of the same product for different customer size and needs. However, a customer needs to upgrade to larger central processing equipment once the number of ports required and/or call-processing requirements exceed the capacity of the central processing equipment.

Current multimedia communication systems use a central processing equipment and simple user telephone terminal sets. These simple user terminal sets are referred to as “stimulus terminals” as they simply send user stimuli such as key presses to the central processing equipment. In large systems, the central processing equipment is generally a very powerful computer controlling a number of functions on circuit boards called line cards, which connect telephone sets to the computer. The central processing equipment receives hook-switch information and key presses known in the art as DTMF (Dual Tone Multi-Frequency) tones from the telephone sets, and provides feedback to the telephone sets for example by sending a dial-tone or a ringing tone to the telephone sets. By interpreting the key presses, the central processing equipment controls the interconnection of the telephone sets based on numbers dialed by the telephone sets.

Call processing functionality such as voice mail, call forwarding, call park and call park pickup, and paging has been provided using central processing equipment. To provide call processing functionality, the central processing equipment maintains information associated with other terminal sets such as user and terminal options, which is required to provide the call processing functionality. In particular, the central processing equipment updates the maintained information every time new information is received from other terminal sets. By updating the maintained information the central processing equipment is capable of providing call processing functionality for the terminals by looking-up the necessary information.

A system which makes use of a central call processing equipment to provide call processing functionality is not well suited for scalability and, as discussed above, when the capacity of the central call processing equipment is exceeded an upgrade is required. In addition, the central call processing equipment adds costs to the total cost of the communication solution. Finally, in such systems, since call processing functionality is provided centrally system reliability and availability can be compromised due to failure of the central processing equipment for example.

### SUMMARY OF THE INVENTION

A method involves, at a network device, receiving information; storing the information; sending the information to one or more other network devices; and using the information and the network device to provide local call facilitating functionality.

The local call facilitating functionality can be for example any call processing functionality such as any one of voice mail, call forward, call transfer, call park and call park pick, and back-up services, or any call related functionality such as for example directory services, and administrative services.

In some embodiments of the invention, the information is received from a user input at the network device or from another network device.

In some implementations the method is applied at each of a plurality of network devices in a system, and the information is distributed to each network device. In some embodiments of the invention, each network device that receives the information from another network device sends the information to only one other network device and the information cascades from one of the network devices to another. In other embodiments of the invention, each one of the network devices sends the information received to two or more other network devices, resulting in the information being distributed to the network devices in a hierarchical manner. In yet other embodiments of the invention, a network device that receives information as part of a user input multicasts the information to the other network devices as part of a multicast message. In some implementations, the information being distributed allows the network devices to provide the call facilitating functionality locally without the use of a central processing equipment. In some implementations users can perform administrative from any network device and information associated with the changes is propagated to other network devices using any one of the above methods. In some of these implementation, at any one moment in time only one network device has exclusive access to a resource for allowing a user to perform a particular type of administrative change thereby preventing another user at another network device from performing an administrative change of the same type.

In accordance with a first broad aspect, the invention provides a method that involves, at a network device, receiving information; storing the information; sending the information to one or more other network devices; and using the information to provide local call facilitating functionality.

In some embodiments of the invention, the above method is applied at each one of a plurality of network devices and each network device determines which of the plurality of network devices the information is to be sent.

In some embodiments of the invention, the information that is distributed includes at least one of information for a phone list, administration information, and routing information.

In accordance with a second broad aspect, the invention provides a network device having an interface adapted to receive information and a memory for storing the information. The device also has a processor adapted to provide first instructions for sending the information to one or more other network devices. The processor is also adapted to use the information to provide second instructions for providing local call facilitating functionality.

In some embodiments of the invention, each network device is one of a VOIP (Voice over Internet Protocol) telephone, a terminal set, a packet based telephone, a video phone, a PC (Personal Computer), a PDA (Personal Digital Assistant), a soft phone, a wireless device, a wireless telephone, and a gateway device.

In accordance with a third broad aspect, the invention provides a system having a plurality of network devices. Each network device has an interface adapted to receive information; a memory for storing the information; and a processor adapted to provide first instructions for sending the information to one or more respective other network devices. The processor is also adapted to use the information to provide second instructions for providing local call facilitating functionality. Furthermore, the respective other network devices of each of the plurality of network devices collectively form all of the plurality of network devices to allow the information to be distributed to all of the plurality of network devices.

In accordance with a fourth broad aspect, the invention provides an article of manufacture having a computer usable medium having computer readable program code means embodied therein. The computer readable code means in the article of manufacture has computer readable code means for, at a network device, receiving information; computer readable code means for storing the information. The computer readable code means in the article of manufacture also has computer readable code means for providing first instructions for sending the information to one or more other network devices; and computer readable code means for using the information to provide second instructions for providing local call facilitating functionality.

### BRIEF DESCRIPTION OF THE DRAWINGS

Preferred embodiments of the invention will now be described with reference to the attached drawings in which:

FIG. 1 is an example implementation of a system which makes use of network based distributed peer-to-peer call processing;

FIG. 2A is a table of a terminal set of FIG. 1;

FIG. 2B is a phone list containing information on members of a corporation;

FIG. 2C is a list of rules that are distributed among terminal sets and a TTI of FIG. 1;

FIG. 3 is a flow chart of a method of transmitting information between network devices in a network, in accordance with an embodiment of the invention;

FIG. 4A is a basic block diagram of a distributed peer-to-peer network;

FIG. 4B is a basic block diagram of a another distributed peer-to-peer network;

FIG. 5A is a flow diagram of messages being sent and received by network devices of FIG. 4A, using the method of FIG. 3;

FIG. 5B is another flow diagram of messages being sent and received by the network devices of FIG. 4A, using the method of FIG. 3;

FIG. 5C is another flow diagram of messages being sent and received by network devices, using the method of FIG. 3;

FIG. 5D is yet another flow diagram of messages being sent and received by network devices, using the method of FIG. 3;

FIG. 6A is a block diagram of network devices arranged in a tree-like structure;

FIG. 6B is another block diagram of some of the network devices of FIG. 6A which are located at a main office and arranged in another tree-like structure;

FIG. 6C is yet another block diagram of some of the network devices of FIG. 6A, which are located at a remote office and arranged in yet another tree-like structure;

FIG. 7A is a Table containing routing information for use in distributing information; and

FIG. 7B is a signal flow diagram of messages being sent among network devices, according to the routing information contained in the Table of FIG. 7A, to distribute information; and

FIG. 8 is a data packet containing information being distributed using the method of FIG. 3;

FIG. 9 is a signal flow diagram of messages being sent between some of the network devices of FIG. 5C for synchronizing information at the network devices;

FIG. 10 is a signal flow diagram of messages being sent between some of the network devices of FIG. 5C for obtaining exclusive access to a resource; and

FIG. 11 is a flow chart of a method used by the network devices of FIG. 5C in locating the resource.

### DETAILED DESCRIPTION OF THE PREFERRED EMBODIMENTS

Some call processing functionalities such as voice mail, call forwarding, call park and call park pickup, backup services, and paging for example and some call related functionalities such as directory services, and administrative services for example have been implemented using central processing equipment. In some embodiments of the invention, at least one of the call functionalities that normally would be performed at the central processing equipment is provided locally by the network devices within the network. To do so, the network devices maintain information that is used by the network devices to provide call facilitating functionality, such as any one of the above call processing and call related functionalities, locally at the network devices.

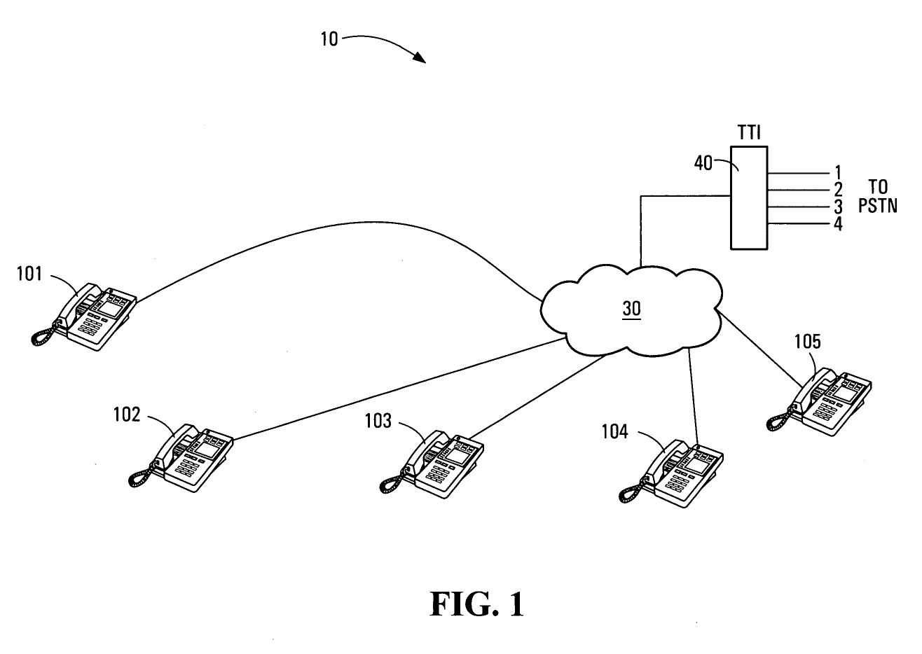

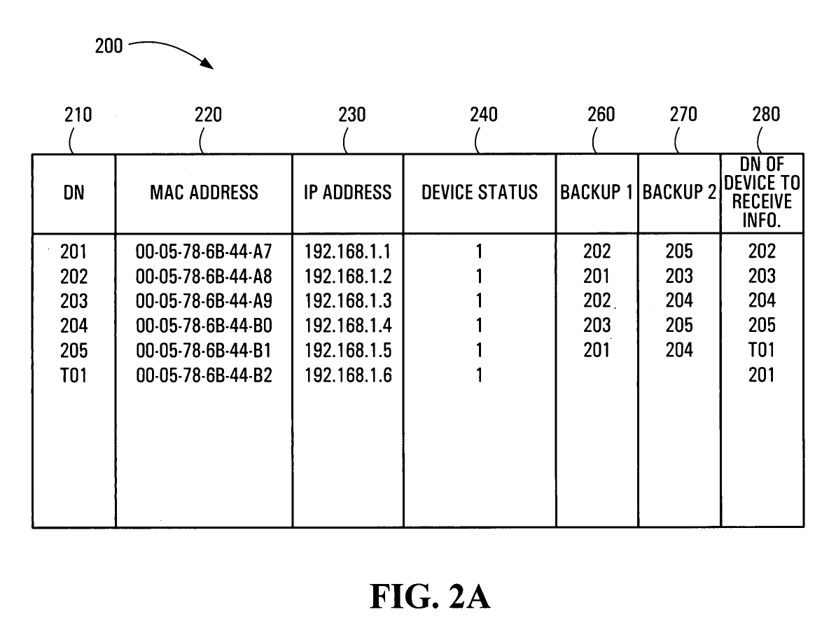

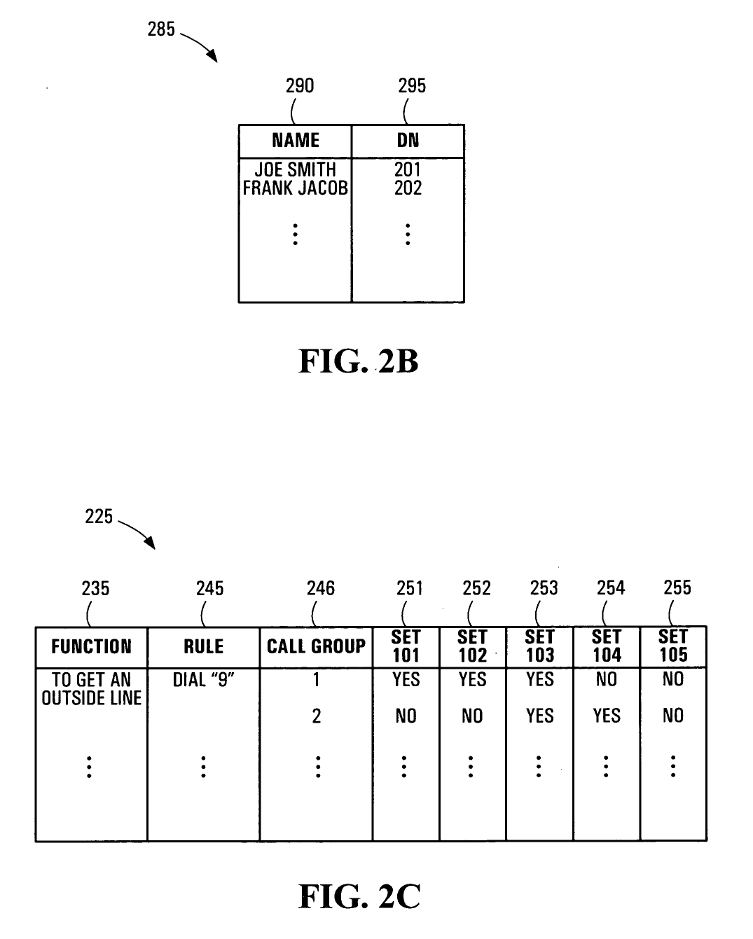

In some embodiments of the invention, information is distributed between the network devices for use by the network devices in providing local call facilitating functionality. In some embodiments of the invention, the information is transmitted for example as data packets each having a header and a payload; however, it is to be clearly understood that the invention is not limited to transmitting the information using the data packets and any suitable means of transporting the information may be used. However, prior to describing how the information is distributed, a description of how the above call facilitating functionalities can be implemented will be described with reference to FIGS. 1, 2A, 2B, and 2C for an example implementation of a distributed peer-to-peer network.

Referring to FIG. 1, shown is an example implementation of a system generally indicated by 10 which makes use of network based distributed peer-to-peer call processing.

The system 10 has a TTI (Thin Trunk Interface) 40 and five terminal sets 101, 102, 103, 104, 105 on a network 30. The network 30 may be for example a LAN (Local Area Network). In the example of FIG. 1 there are five terminal sets 101, 102, 103, 104, 105; however, more generally there are a total of N terminal sets where N≧2. Furthermore, in some implementations N can be a large number, for example in the thousands. The TTI 40 is, for example, a basic Analog or digital T1/E1 interface or any other suitable PSTN interface and provides a local central office or PSTN (Public Switched Telephone Network) interworking interface. The TTI 40 is coupled to a number of telephone “lines” 1, 2, 3, 4. Lines 1, 2, 3, 4 are wire pairs representative of facilities provided by a local central office or PSTN (not shown). In some implementations, there are many lines requiring multiple thin trunk interfaces. For example, in one implementation, 8 lines are required for connection to the PSTN and a second thin trunk interface is added to the system 10. It is to be understood that the system 10 of FIG. 1 is only a specific example. For example, in some implementations the network 30 forms part of a larger network that is a collection of smaller networks interconnected by way of VPN (Virtual Private Network) connections for example.

In another example implementation there are two or more networks each having a TTI and at least one network device capable of providing call facilitating functionality locally. An external call received from a network device on another network is routed through a respective TTI on the network on which the network device intended to receive the call resides. The network device receiving the external call provides local call related functionality for the external call if required.

In the example, call facilitating functionality such as call forwarding, voice mail, call park and call park pickup, paging, and other features such as time synchronization, backup features, peer discovery, directory services, and administrative services may be provided locally at network devices within a network. Some of these functionalities are described in U.S. Provisional Patent Application No. 60/441,481 entitled “DISTRIBUTED PEER-TO-PEER CALL TRANSFER SYSTEM, METHOD AND TELEPHONE TERMINALS” and filed Jan. 22, 2003; U.S. Provisional Patent Application No. 60/441,121 entitled “DISTRIBUTED PEER-TO-PEER CALL FORWARDING SYSTEM, METHOD AND TELEPHONE TERMINAL” and filed Jan. 21, 2003; U.S. Provisional Patent Application No. 60/434,813 entitled “DISTRIBUTED PEER-TO-PEER VOICE MAIL SYSTEM, METHOD AND TELEPHONE TERMINALS” and filed Dec. 20, 2002; U.S. Provisional Patent Application No. 60/473,877 entitled “DISTRIBUTED PEER-TO-PEER CALL PARK AND CALL PARK PICKUP SYSTEM, METHOD AND TELEPHONE TERMINALS” filed May 29, 2003; U.S. Provisional Patent Application No. 60/518,646 entitled “PEER-TO-PEER DISCOVERY SYSTEM, METHOD AND NETWORK DEVICES” filed Nov. 12, 2003; U.S. Provisional Patent Application No. 60/523,703 entitled “PEER BACK-UP IN A DISTRIBUTED PEER-TO-PEER NETWORK: SYSTEM, METHOD AND NETWORK DEVICES” filed Nov. 21, 2003; U.S. Provisional Patent Application No. 60/523,140 entitled “TIME SYNCHRONIZATION OF NETWORK DEVICES IN A NETWORK: SYSTEM, METHOD AND NETWORK DEVICE” filed Nov. 19, 2003; U.S. Provisional Patent Application No. 60/524,041 entitled “SYSTEM, METHOD AND NETWORK DEVICES FOR PAGING IN A NETWORK” filed Nov. 24, 2003; U.S. Patent Application No. 60/434,813 entitled “VOICE MAIL SYSTEM, METHOD AND NETWORK DEVICES” filed Dec. 22, 2003 U.S.; patent application Ser. No. 10/760,530 entitled “CALL FORWARDING SYSTEMS, METHODS AND NETWORK DEVICES” filed Jan. 21, 2004; U.S. patent application Ser. No. 10/762,754 entitled “CALL TRANSFER SYSTEM, METHOD AND NETWORK DEVICES” filed Jan. 22, 2004; and U.S. Patent Application entitled “CALL PARK AND CALL PARK PICKUP SYSTEMS, METHODS AND NETWORK DEVICES” filed May 24, 2004<attorney docket number 50447-12>, all of which are incorporated herein by reference. It is to be clearly understood that embodiments of the invention are not limited by the type of call facilitating functionality being provided.

What happens when a terminal set become available will now be described with reference to terminal set 101 as an example. When terminal set 101 is initially connected to the network 30 it performs a peer discovery. At this point terminal set 101 undergoes a discovery of peer network devices such as terminal sets 102, 103, 104, 105 and TTI 40 by way of messages between terminal set 101 and terminal sets 102, 103, 104, 105 and TTI 40. Peer discovery is described in detail in the above U.S. Provisional Patent Application No. 60/518,646. Once the peer terminal sets are discovered, information is exchanged between the terminal set 101 and its peer network devices. At least part of the information exchanged in the messages is included in a table illustrated by way of example as shown in FIG. 2A. The table is generally indicated by 200, contains routing information for each of terminal sets 101, 102, 103, 104, 105 and TTI 40 and is stored at each of terminal sets 101, 102, 103, 104, 105, and TTI 40. A column 210 contains a DN (Directory Number) for each terminal set 101, 102, 103, 104, 105. For example, in one case terminal sets 101, 102, 103, 104, 105 have DNs 201, 202, 203, 204, 205, respectively. The DN uniquely identifies terminal sets 101, 102, 103, 104, 105 within the network 30. In the example implementation the TTI 40 is not a user dialable device. TTI 40 is given a different identifier T01 so that it can nonetheless be identified by other network devices. A column 220 has as entries a MAC (Media Access Control) address for each terminal set 101, 102, 103, 104, 105 and TTI 40. A column 230 has as entries an IP (Internet Protocol) address assigned to each terminal set 101, 102, 103, 104, 105 and TTI 40. A column 240 indicates a current device status of each terminal set 101, 102, 103, 104, 105 and TTI 40. For example, in one implementation a “1” indicates that a network device is available and running whereas a “0” indicates that the network device is un-available due to, for example, a failure.

In some implementations, a network device has one or more network devices designated to serve as backup network devices in the event the network device is unavailable to process a call. In particular, if a network device is unavailable to process a call, the call is re-directed to one of its designated backup network devices and the designated backup network device receiving the re-directed call provides call functionality for the network device that is unavailable. In the example of FIGS. 1 and 2A for each terminal set 101, 102, 103, 104, 105 there are two network devices designated as backup network devices which are identified in columns 260, 270 of Table 200. For example, network devices having DNs 202, 205 in columns 260, 270, respectively, are designated as backup network devices for terminal set 101 which has DN 201. In the example implementation, the TTI 40 (T01) is not backed up; however, in some implementations the TTI 40 is backed up by one or more network devices. As shown in Table 200, there are preferably two backup network devices designated for each network device; however, more generally, there is one or more backup network devices designated for each network device.

In the example implementation, information is transmitted between terminal sets 101, 102, 103, 104, 105 for use by the terminal sets 101, 102, 103, 104, 105. The TTI 40 also transmits and receives information shared with terminal sets 101, 102, 103, 104, 105. The information transmitted is used by terminal sets 101, 102, 103, 104, 105 and TTI 40 to provide call facilitating functionality locally. Some of this information might be for example information from Table 200 collected during peer discovery. However, as will be discussed in more detail below other information may be transmitted among terminal sets 101, 102, 103, 104, 105 and TTI 40.

In accordance with an embodiment of the invention, one method of distributing information is to have the information cascade through terminal sets 101, 102, 103, 104, 105 and TTI 40. For example, designated network devices are identified in a column 280. For example, in column 280 terminal set 102 having DN 202 is designated to receive information from terminal set 101 which has DN 201, and terminal set 103 having DN 203 is designated to receive the information from terminal set 102 which has DN 202. As such when terminal set 101 has information that needs to be distributed to terminals sets 102, 103, 104, 105 and TTI 40, terminal set 101 sends the information to terminal set 102. Terminal set 102 receives and stores the information and then forwards the information to terminal set 103. This procedure continues until all of terminal sets 101, 102, 103, 104, 105, and TTI 40 have been updated with the information. Such a method and other methods of distributing information are discussed in further detail below.

In our example implementation, in columns 260, 270, 280 the backup network devices and the assigned network devices for distributing information are identified by their DNs for purposes of clarity. Some implementations make use of DNs to identify network devices as illustrated. In other implementations, addresses such as MAC addresses for example are maintained in columns 260, 270, 280 to identify the network devices. Furthermore, any unique identifier for the network devices may be used.

The Table 200 is shown as an illustrative example of the type of routing information that might be maintained; however, the invention is not limited to the illustrative example of FIG. 2A and in other implementations fewer or additional routing information is maintained in the Table 200. More generally, the Table 200 may contain any information on network devices, which is maintained for providing local functionality such as for example voice mail, call forward, paging, backup services, and call park and call park pickup functionality. Other information that may also be maintained in Table 200 might be for example, network device type identifiers, timestamps for synchronization purposes, network class identifiers for identifying a network class on which a network device is connected, and activity indicators identifying whether network devices are active.

In addition to providing the above call facilitating functionalities, other functionalities can be provided locally. For example, in one implementation the system 10 of FIG. 1 is used by a corporation and each terminal set 101, 102, 103, 104, 105 is capable of providing directory services to users at terminal sets 101, 102, 103, 104, 105 within the corporation. For this purpose each terminal set 101, 102, 103, 104, 105 maintains a corporate phone list of members within the corporation. An example of such a list is shown in FIG. 2B. The phone list is generally indicated by 285 and contains information on members of the corporation. A column 290 indicates the names of the members and a column 295 identifies DNs of respective terminal sets of the members. The phone list 285 of FIG. 2B contains only information on names and DNs; however, it is to be clearly understood that the invention is not limited by the type of information contained in the phone list 285. For example, in another implementation, the phone list 285 also contains for example emails of each member and/or any other suitable information that may be useful to the members.

To maintain list 285, users at terminal sets 101, 102, 103, 104, 105 enter information and, as will be described in more detail below, this information is distributed to other ones of terminal sets 101, 102, 103, 104, 105.

With reference back to FIG. 1, in some embodiments of the inventions, the terminals sets 101, 102, 103, 104, 105 and the TTI 40 are maintained by a system administrator who can access the system 10 and, for example, provide instructions as to how call facilitating functionalities are to be implemented. The system administrator inputs information on how a particular call facilitating functionality is to be implemented. This information is then distributed to other ones of terminals sets 101, 102, 103, 104, 105 and TTI 40. The information might include for example rules on how to implement call facilitating functionalities. In FIG. 2C, shown is a list of rules generally indicated by 225, that are distributed among of terminals sets 101, 102, 103, 104, 105 and TTI 40. A column 235 identifies call facilitating functions and a column 245 identifies respective rules for the functions identified in column 235. For example, a rule might be: to get an outside line, dial “9”. Other rules or option settings might be related to, for example, one or more of the following: 1) imposing restrictions on which network device(s) are allowed to make external calls; 2) what system language to use; 3) administration notification settings; and 4) paging zone definitions and assignments; 5) administrations passwords; and 6) DN re-assignment. A column 246 identifies various call groups to which the functions of column 235 are applied and columns 251, 252, 253, 254, 255 indicate whether or not terminal sets 101, 102, 103, 104, 105, respectively, are within the call groups. For example, terminal sets 101, 102, 103 are part of call group 1; however, terminal sets 104, 105 are not part of this group.

Information Distribution

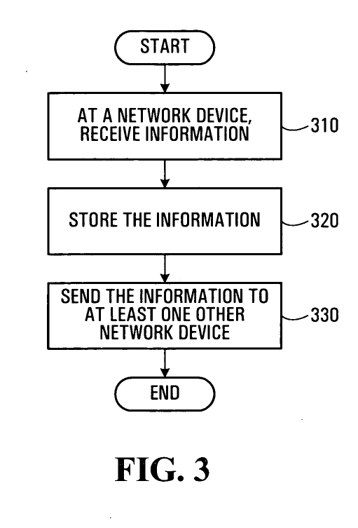

As discussed above, to provide local call facilitating functionalities such as voice mail, call forwarding, call park and call park pickup, back-up services, paging, directory services, and administrative services, network devices on a network make use of information distributed among the network devices. The method by which the information is transmitted from one of the network devices to another will now be described with reference to FIG. 3.

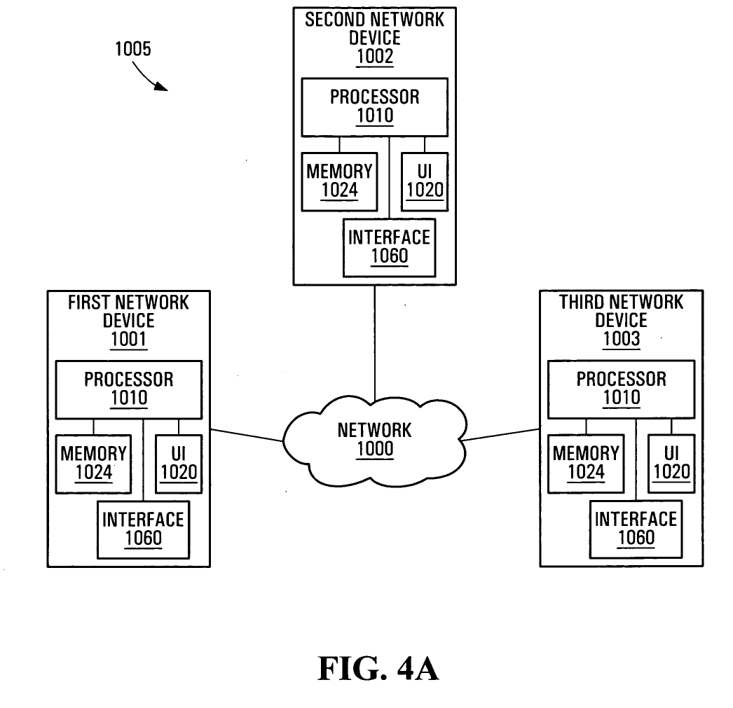

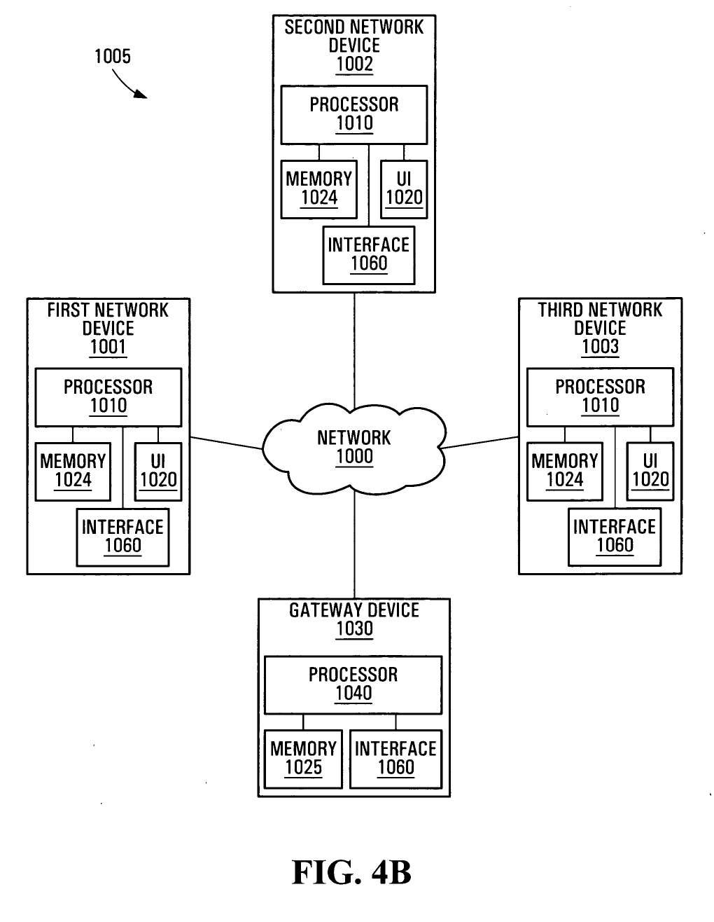

Referring to FIG. 3, shown is flow chart of a method of transmitting information between network devices in a network, in accordance with an embodiment of the invention. At step 310, information is received at a network device. At step 320 the information is stored. In some implementations, the information is stored only if it corresponds to new information not found at the network device or information that is being changed. At step 330 the information is sent to at least one other network. In particular, as will be discussed in further detail below, at step 330 the information is sent only if it needs to be forwarded. The information is adapted for use by the network device and the other network device(s) in providing local call facilitating functionality. The types of information that can be received and sent include but is not limited to the above information described with reference to FIGS. 2A to 2C. An example implementation of the method of FIG. 3 will now be described in more detail with reference to FIGS. 4A and 4B.

Referring to FIG. 4A, shown is a basic block diagram of a distributed peer-to-peer network. In FIG. 4A shown are first, second, and third network devices 1001, 1002, 1003, respectively, on a network 1000 of a system 1005. Each network device 1001, 1002, 1003 has an interface 1060, a UI (User Interface) 1020, a memory 1024, and a processor 1010.

Each network device 1001, 1002, 1003 is adapted to implement the method of FIG. 3. In particular, for each network device 1001, 1002, 1003 the UI 1020 is adapted to receive information from a user input, and the interface 1060 is adapted to receive information in messages sent by other ones of the network devices 1001, 1002, 1003. The processor 1010 is adapted to store in the memory 1024 information received from the interface 1060 and the UI 1020, and provide instructions for sending the information to at least one other network device of the network devices 1001, 1002, 1003.

Each network device 1001, 1002, 1003 may be for example a terminal set, a packet based telephone, a VOIP (Voice over Internet Protocol) telephone, a video phone, a PC (Personal Computer), a PDA (Personal Digital Assistant), a soft phone, a wireless device, or a wireless telephone suitably programmed and configured to implement the method of FIG. 3. For example, in one implementation, the functionality of network devices 1001, 1002, 1003 is implemented in the terminal sets 101, 102, 103, 104, 105 of FIG. 1.

The network devices 1001, 1002, 1003 implement at least one call facilitating functionality locally. For example, in one implementation, the network devices 1001, 1002, 1003 each implement at least one of call forwarding, voice mail, call park and call park pickup, paging, and other call related functionalities such as time synchronization, backup features, peer discovery, directory services, and administrative services. Some of these functionalities are described in the above U.S. provisional patent applications and U.S. patent applications.

In some embodiments of the invention, for purposes of providing local directory services, the processor 1010 of each network device 1001, 1002, 1003 maintains in memory 1024 a database such as phone list 285 of FIG. 2B for example. When a user inputs new information using the UI 1020, the phone list 285 is updated and information is distributed to other ones of network devices 1001, 1002, 1003 using any one of the methods described above with reference to FIGS. 3, 4A, and 4B and methods described below. An example of the type of information that might be input as a user input is a name for use as a “display name” to be displayed. The user input might involve a change to an existing display name or simply an input of a new name. It is to be clearly understood that this is only one example of the type of information that can be input and distributed and any other suitable information can also be input and distributed including for example any information in phone list 285.

To access the phone list 285, the user provides a user input at the UI 1020. In one case the user input is in the form of a request for information on a particular member and in another case the user input is in the form of a request for the entire phone list 285. The information requested is displayed using the UI interface 1020.

In some embodiments of the invention, for purposes of providing local administrative services, the processor 1010 of each network device 1001, 1002, 1003 maintains in memory 1024 a database such as Table 225 of FIG. 2C for example. When a user inputs new information using the UI 1020, the Table 225 is updated and the new information is distributed to other ones of network devices 1001, 1002, 1003.

In another embodiment of the invention, the system 1005 also has a gateway device connected to the network 1000 with the gateway device having at least some call processing functionality of network devices 1001, 1002, 1003. As shown in FIG. 4B, there is a gateway device 1030 having a processor 1040, a memory 1025, and an interface 1060. The gateway device 1030 might be a TTI (Thin Trunk Interface) for example. The gateway device 1030 provides access to the network 1000 for external calls external to the network 1000. For external calls to and from external network devices (not shown) outside the network 1000, the gateway device 1030 is adapted to provide local call processing functionality for the external network devices outside the network 1000. To do so the gateway device 1030 is also adapted to implement the method of FIG. 3. In particular, upon receipt of information from any one of the network device 1001, 1002, 1003, the processor 1040 of the gateway device 1030 is adapted to store the information in the memory 1025.

The invention is not limited by the type of messaging used to transmit the information between network devices. Example protocols include for example, but are not limited to, a SIP (Session Initiation Protocol) and a H.323 standard.

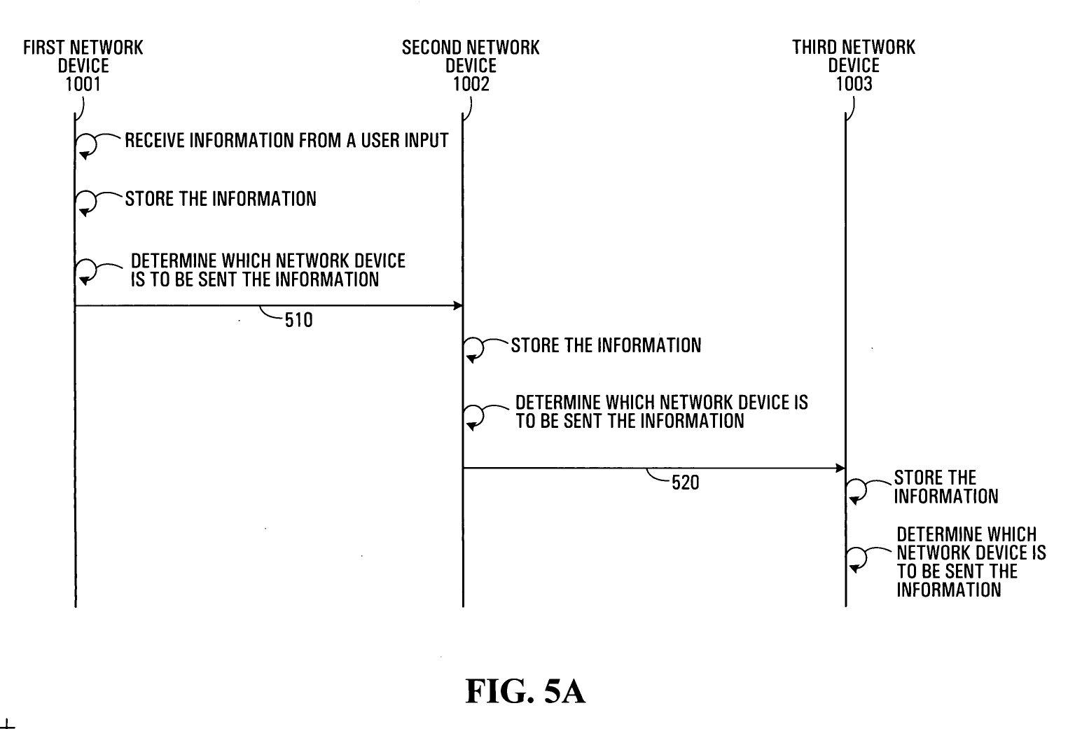

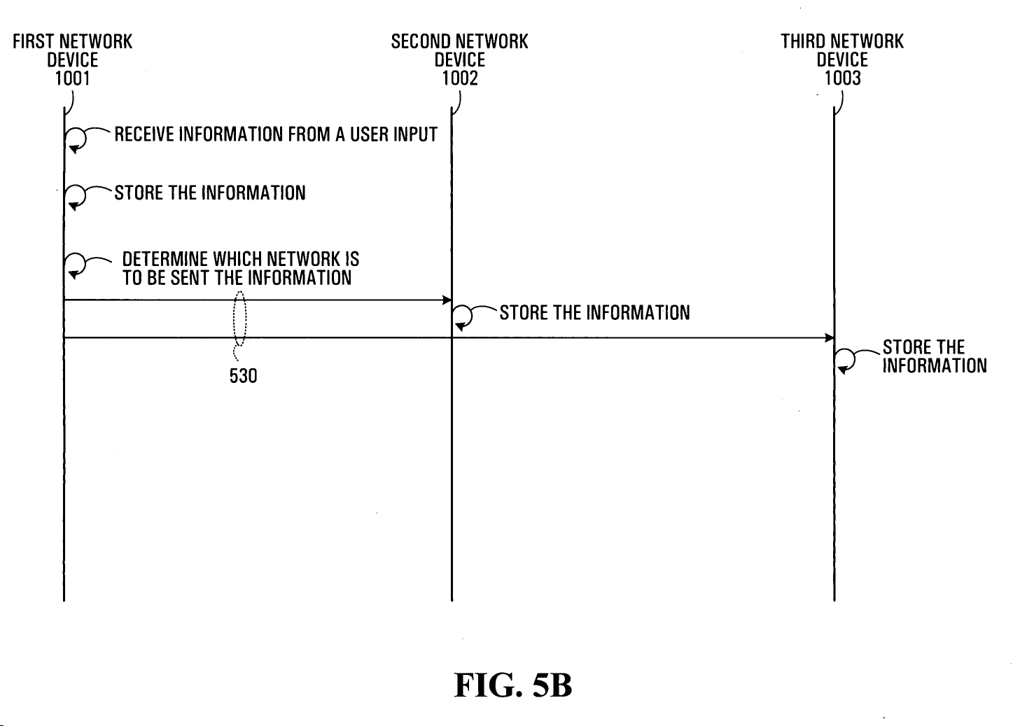

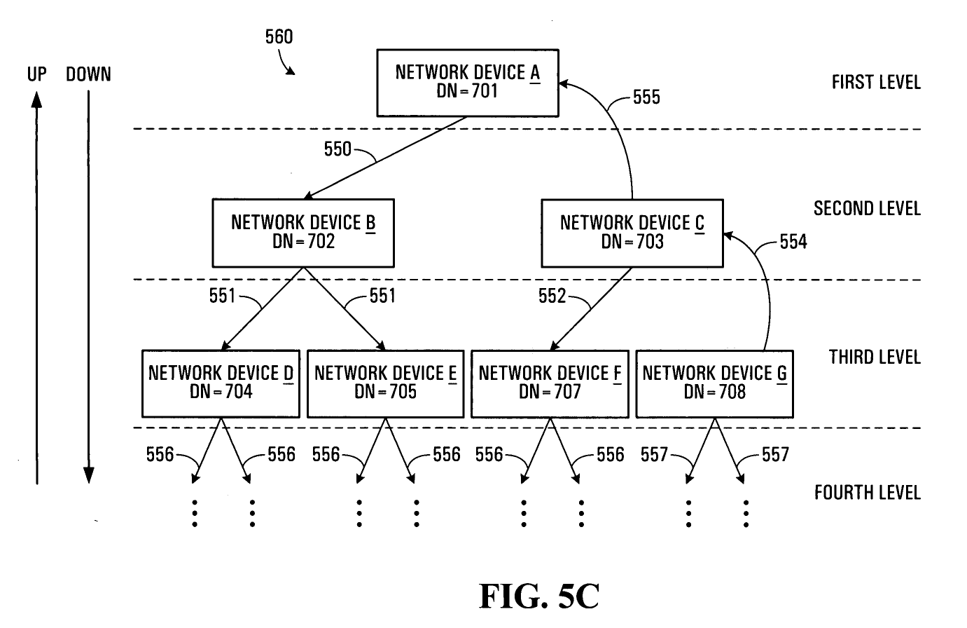

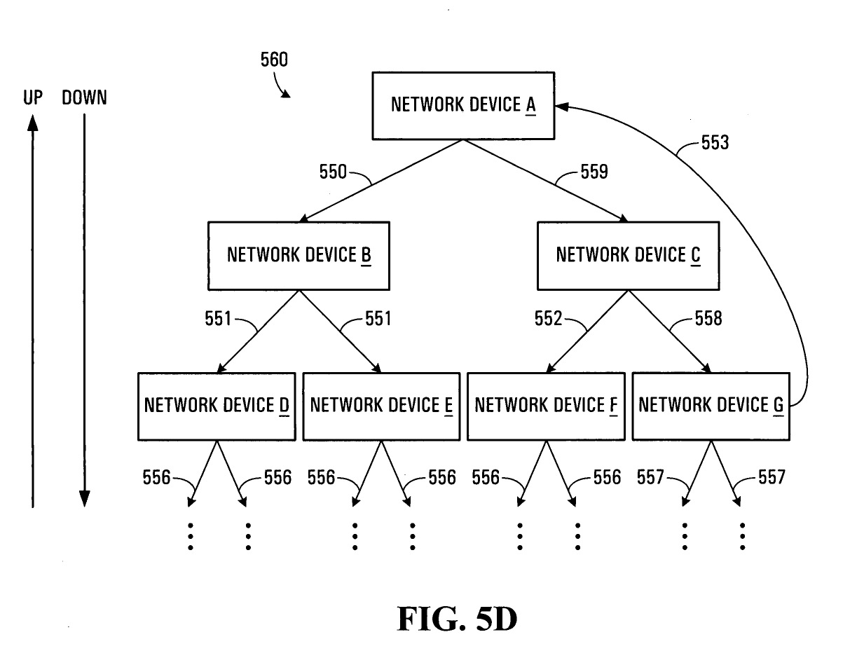

There are several ways of implementing the method of FIG. 3. Some of the possible ways will now be described with reference to FIGS. 4A, 4B, 5A, 5B, 5C, and 5D.

With reference to FIGS. 4A and 4B, in some embodiments of the invention when any one of network devices 1001, 1002, 1003 receives from any one of interface 1060 and UI 1020 information that is to be transmitted to other network devices, the processor 1010 determines which of the network devices 1001, 1002, 1003 is to be sent the information. An example implementation will now be described with reference to FIG. 5A in which each of the network devices 1001, 1002, 1003 receives information and sends the information to one other network device of network device 1001, 1002, 1003. Such a method is referred to as a cascade method.

Referring to FIG. 5A, shown is a flow diagram of messages being sent and received by network devices 1001, 1002, 1003 of FIG. 4A, using the method of FIG. 3. With reference to FIG. 4A, in an example implementation information is received from a user input at the UI 1020 of the first network device 1001. The processor 1010 of the first network device 1001 stores the information and determines which network device is to be sent the information. This is done for example by looking up a table such as the Table 200 of FIG. 2A which contains designations in column 280. In the example implementation the designations are determined on the basis of DNs of the network devices. For example, a network device with DN 201 is to send information to a network device having a next higher DN corresponding to DN 202. Similarly, the network device with DN 202 sends information to a network device with DN 203; the network device with DN 203 sends the information to a network device with DN 204. This is clearly shown with reference to columns 210, 280 of Table 200 of FIG. 2A where for example a terminal set with DN 201 has, as a terminal set designated to receive information, a terminal set with DN 202, and the terminal set with DN 202 has, as a terminal set designated to receive the information, a terminal set with DN 203.

In our example implementation, the network device that is to receive the information from the first network device 1001 corresponds to the second network device 1002. The first network device 1001 then sends a message 510 containing the information to the second network device 1002. The second network device 1002 receives the message 510 and stores the information contained in the message 510. The second network device 1002 determines that the third network device 1003 is to receive the information and sends a message 520 containing the information to the third network device 1003. The third network device 1003 receives the message 520 and stores the information contained in the message 520. The third network device 1003 determines which network device is to receive the information; however, in this case all network devices 1001, 1002, 1003 have been updated with the information and there is no other network device to which the information is to be sent.

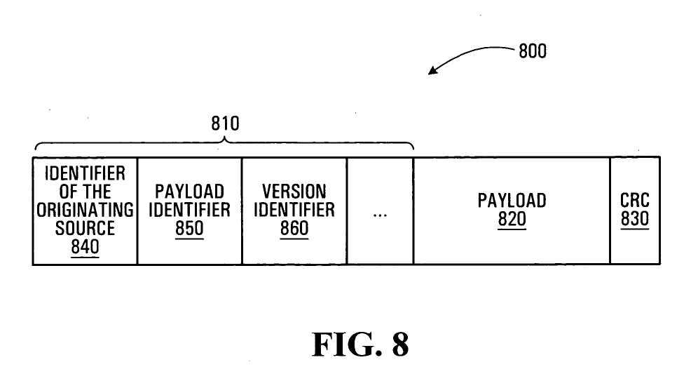

In the example implementation of FIG. 5A, the first network device 1001 is designated to receive information from the third network device 1003; however, since the information being distributed originates from the first network device 1001 there is no need for the third network device 1003 to forward the information to the first network device 1001. In the example implementation, the messages 510, 520 contain an identifier of the originating source of the information, which happens to be the first network device 1001 in this case. In the example implementation, as shown in FIG. 8, the messages 510, 520 are in the form of a data packet, which is generally indicated by 800. The data packet has a header 810, a payload 820 containing the information being distributed, and a CRC (Cyclic Redundancy Check) 830. The header 810 has an identifier 840 of the originating source, the originating source in this example being network device 1001. The header 810 also has a payload identifier 850 and a version identifier 860. The payload identifier 850 is used for identifying the type of payload. In some implementations the payload identifier 850 is also used to indicate that the payload is to be stored for purposes of providing call facilitating functionality; however, in our example implementation the information is distributed through ports (not shown) at the network devices 1001, 1002, 1003 that are dedicated to information to be stored and distributed, and there is no need to indicate in the data packet 800 whether the information in the payload is to be stored for purposes of providing call facilitating functionality. For example, in the example implementation at any one of network devices 1001, 1002, 1003 a first port is dedicated to receiving voice information; a second port is dedicated to receiving signaling information; and a third port is dedicated to receiving administration information such as information to be distributed for purposes of providing local call facilitating functionality.

In some embodiments of the invention the types of payloads are categorized according to call facilitating functionality. For example, information for use in providing local call forwarding functionality might be of one type while dialing rules might be of another type; however, it is to be clearly understood that the invention is not limited to categorizing payload type according to call functionality and the payload types can be categorized in any suitable manner.

The version identifier 860 is used to indicate which version of the particular type of payload is being transmitted. The version identifier 860 is for example a sequence number or a timestamp. When the network devices 1002, 1003 receive the data packet 800, a verification is made as to whether the information is to be stored. In the example implementation the payload identifier 850 identifies the type of payload as information related to dialing rules and the version identifier 860 is a timestamp. When receiving the data packet 800, the network devices 1002, 1003 may already have a version of information related to dialing rules together with its respective timestamp. The network devices 1002, 1003 each compare the timestamp of the data packet 800 with that of the existing information related to dialing rules to determine whether a new version of information related to the dialing rules is being distributed. If the information being distributed corresponds to a newer version of dialing rules the information is stored.

The identifier 840 of the originating source is for example a DN or any other suitable identifier of network device 1001. To determine whether there is another network device that is to receive the information each network device 1002, 1003 determines whether the originating source corresponds to the network device the information is to be sent using the identifier 840. For example, in the example implementation, the third network device 1003 determines that it is to send the information to the first network device 1001 using a table look-up; however, the identifier 840 received with the message 520 identifies the first network device 1001 as the originating source. Therefore every network device has received the information and there is no need for the third network device 1003 to forward the information.

In another implementation the third network device 1003 sends a message to the first network device 1001 for confirming that distribution is complete. Furthermore, in some implementations if, for example, the first network device 1001 does not receive a confirmation within a predetermined period of time that the information has been distributed to all other network devices, then the first network device 1001 re-sends the information to the second network device 1002 and the process of FIG. 5A is repeated.

Although the cascade method of FIG. 5A is applied to three network devices, it is to be clearly understood that this method scales to an arbitrary number of network devices.

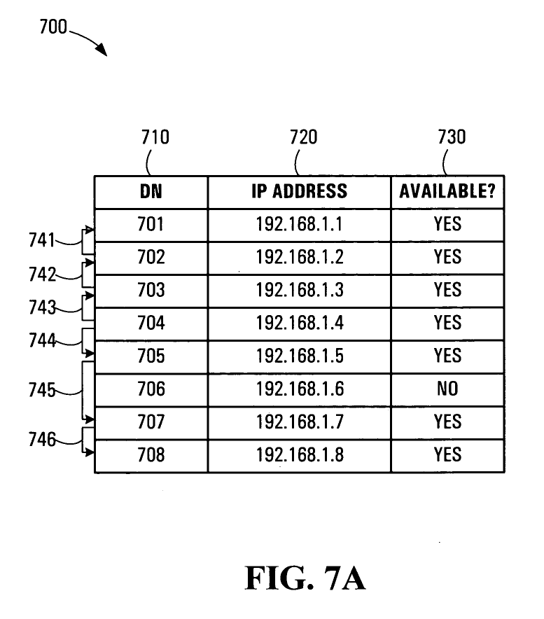

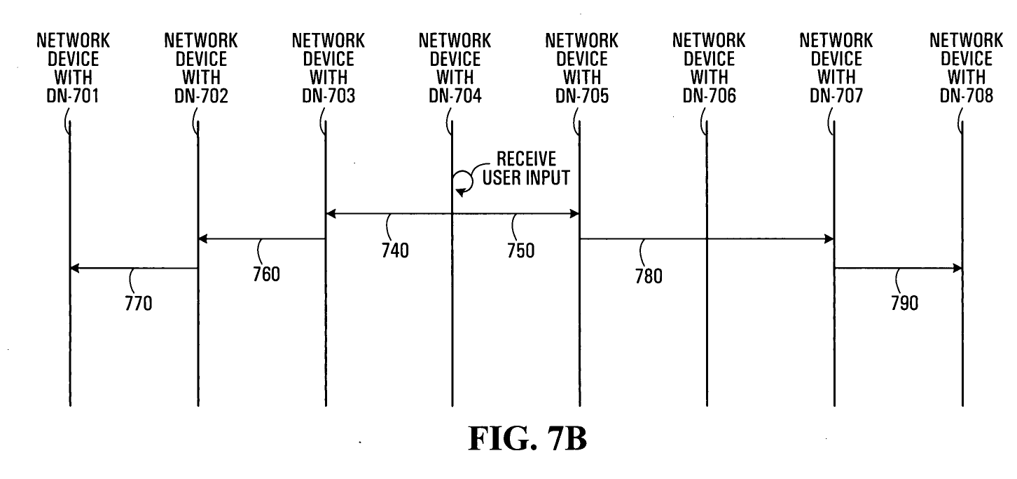

In another example implementation, there is no identifier 840 of the originating source in the messages carrying the information. Such an implementation will now be described with reference to FIGS. 7A and 7B. In FIG. 7A, shown is a table, generally indicated by 700, containing routing information for use in distributing information. Each network device maintains a copy of Table 700 using for example a method described in the above U.S. Provisional Patent No. 60/518,646. In the example implementation there are 8 network devices on a network. A column 710 indicates respective DNs of the eight network devices. A column 720 indicates the respective IP addresses of the eight network devices, and a column 730 indicates whether the network devices are available. For example, the network devices with DNs 701 to 705 and 707 to 708 are available and the network device with DN 706 is not available. Such a table is maintained on the 8 network devices. In the example implementation, the network device receiving information at a user input sends the information to two other available network devices and the remaining network devices that are available each receive; store and send the information to one other network device until all of the network devices that are available have received the information. This is reflected in Table 700 with reference to arrows 741, 742, 743, 745, 746. For example, a network device with DN 704 receives information from a user input and sends the information to two other network devices. As shown with reference to FIG. 7B, the network device having DN 704 receives information at a user input. Since the information is received at the user input, the network device with DN 704 is to send the information to two other network devices. The network device having DN 704 looks up its version of Table 700 and sends the information to two network devices having entries in Table 700 that are closest to the entries for the network devices with DN 704. The arrows 743 and 744 point to the two entries next to the entries of the network device with DN 704, which are entries for network devices with DNs 703 and 705, respectively. Similarly, arrow 742 indicates that the network device with DN 703 is to send the information to a network device with DN 702, and arrow 741 indicates that the network device with DN 702 is to send the information to a network device with DN 701.

A network device with DN 706 is not available. As such, the network device with DN 705 must send the information to a next available network device, which happens to be a network device with DN 707 as indicated by arrow 745. Finally, arrow 746 indicates that the network device with DN 707 is to send the information to a network device with DN 708. In such a messaging scheme the only device that sends the information to two other network devices correspond to the network device with DN 704 which the information is received from a user input. As such, in this implementation whether a network service sends the information to one or two other network devices depends on whether the information is received from a user input or from another device. The case when the information is received from another network device will now be described in more detail with reference to Table 700. In this example implementation the information is sent together with an identifier of the network device that sends the information. For example, entries for the network device with DN 702 have as adjacent entries, entries for network devices with DNs 701, 703. When the network device with DN 702 receives the information from one of the network devices with DNs 701, 703 together with the identifier of the network device sending the information, the network device with DN 702 determines which of the network devices with DNs 701, 702 has sent the information using the identifier. In this example implementation the identifier is an IP address and the network device with DN 702 compares the IP address received with those in column 720 of Table 700 to determine the sender of the information. In this case, the network device with DN 702 receives the information and IP address of 192.168.1.3 corresponding to the IP address of the network device with DN 703. Of the two network devices with DNS 701, 703, the network device with DN 701 is therefore the network device that is to receive the information.

Referring back to FIG. 7B responsive to receiving the user input, the network device with DN 704 determines that there are two next available network devices within its version of Table 700 corresponding to network devices with DNs 703, 705. The network device having DN 704 then sends messages 740 and 750 containing the information together with its IP address to network devices with DNs 703 and 705, respectively.

Upon receipt of message 740, the network device with DN 703 looks up its version of Table 700 using the IP address received with the information to identify the network device with DN 702 as the network device which is to be sent the information. The network device with DN 703 then sends a message 760 containing the information to the network device with DN 702 together with its IP address. Upon receipt of the message 760, the network device with DN 702 determines that the network device with DN 701 is to be sent the information by looking up its version of Table 700 and using the IP address received with the information. The network device with DN 702 then sends a message 770 to the network device with DN 701. Upon receipt of the message 770, the network device with DN 701 determines that there is no next available network device that is to be sent the information by looking up its version of Table 700 and using the IP address received with the information.

Similarly, upon receipt of the message 750, the network device with DN 705 looks up its version of Table 700; however, the network device with DN 706 is unavailable and a next available network device corresponds to the network device with DN 707. As such, the network device with DN 705 sends a message 780 containing the information and its IP address to the network device 707. Upon receipt of the message 780, the network device with DN 707 determines that the network device with DN 708 is to be sent the information by looking up its version of Table 700 and using the IP address received with the information. The network device with DN 707 then sends a message 790 containing the information and its IP address to the network device with DN 708. Upon receipt of the message 790, the network device with DN 708 determines by looking up its version of Table 700 and using the IP address received with the information that there is no next available network device that is to be sent the information.

The example implementations of FIGS. 5A, 7A and 7B make use of DNs to determine a next available network device that is to be send information; however, in some cases a DN is not a unique identifier. For example, two network devices that are on different networks may have the same DN. As such, preferably a unique identifier of the network devices such as a MAC (Media Access Control) address for example is employed. Similarly, in the example implementation the IP addresses of column 720 of Table 700 are used to send the messages 740, 750, 760, 770, 780, 790; however, in some cases an IP address is not a unique address but instead a local IP address. As such, preferably a unique identifier of the network devices such as a MAC (Media Access Control) for example is also used to send the messages 740, 750, 760, 770, 780, 790.

Another method of distributing information is referred to as a multicast method. In such a method, a network device that receives information from a user input sends the information to a multicast address, and other network devices listening in on the multicast address receives the information. An example implementation of a multicast method will now be described with reference to FIGS. 4A and 5B. In FIG. 5B, information is received from a user input at the first network device 1001. The information is stored and the first network device 1001 sends a multicast message 530 containing the information to a multicast address. The second network device 1002 and the third network device 1003 are configured to listen in on the multicast address and receive the information. Upon receipt of the information, the second network device 1002 and the third network device 1003 each store the information. In some embodiments of the invention each one of the network devices 1002, 1003 responds to the first network device 1001 with a message (not shown) confirming that the information has been received and stored.

Yet another method of distributing information is referred to as a hierarchical method, in which each network device receiving information sends the information as a unicast message to two or more other network devices. An example implementation of a hierarchical method of distributing information will now be described with reference to FIG. 5C. Referring to FIG. 5C, shown is another flow diagram of messages being sent and received by network devices, using the method of FIG. 3. In particular, a plurality of network devices A, B, C, D, E, F, G are arranged in a tree-like structure generally indicated by 560 to illustrate how information is distributed. In the tree-like structure 560 only 7 network devices are shown for clarity. More generally there are 3 or more network devices forming. The tree-like structure 560 provides a mapping for distributing information. In this example implementation, each of one of the network devices A, B, C, D, E, F, G makes use of the mapping defined by the structure 560. To do so each network device A, B, C, D, E, F, G maintains a table of active network devices such as. Table 700 of FIG. 7A for example. Each one of network devices A, B, C, D, E, F, G constructs a mapping according to structure 560 using identifiers of the network devices that are available. In table 700 network devices with DNs 701 to 705 and 707 to 708 are available. Referring back to FIG. 5C, network devices A, B, C, D, E, F, G have DNs 701, 702, 703, 704, 705, 707, 708, respectively, and the structure 560 is based on the DNs. In particular, a first level contains network device A which has the lowest DN of 701. A second level contains network devices B, C, which have the next two lowest DNs 702, 703, respectively. A third level also contains network devices D, E, F, G, with DNs 704, 705, 707, 708 respectively. In this way, each network device A, B, C, D, E, F, G obtains a mapping using DNs of available network devices in ascending order. However, it is to be clearly understood that other methods of obtaining a mapping can also be used. For example, network devices can be arranged in a tree-like structure with DNs in descending order instead of ascending order. Furthermore, any other suitable identifier such as an IP address or a MAC address for example can be used instead of a DN.

Given the structure 560, the distribution of information will now be described. In the example of FIG. 5C, the network device G receives a user input containing information to be stored and transmitted to network devices A, B, C, D, E, F. Each one of network devices A, B, C, D, E, F, G sends received information to each one of respective network devices that is on a higher or lower level of the structure 560 and requires the received information. For example, beginning with network device G, the information received is stored and forwarded as messages 557 to two network devices (not shown) on a fourth level of the structure 560. The network device G also sends a message 554 containing the received information up one level to network device C of the second level. The network device C stores information and sends the information as part of a message 555 up one level to network device A of the first level, and as part of a message 552 down one level to network device F of the third level. The network device A stores the information and sends a message 550 containing the information down one level to network device B of the second level. The network device B stores the information and sends the information as part of messages 551 down one level to network devices D, E on the third level. The network devices D, E, F store the information and send messages 556 containing the information to respective network devices (not shown) of the fourth level.

The example of FIG. 5C is only one example of many ways of implementing the hierarchical method. Another hierarchical method will now be described with reference to FIG. 5D. In FIG. 5D, the structure 560 is the same as that of FIG. 5C except that the messaging between the network devices is slightly different. In particular, instead of sending message 554 to network device C as in the example of FIG. 5C, in FIG. 5D the network device G sends a message 553 to network device A. The information can then be distributed down along the structure 560. In particular, in FIG. 5D the message 555 of FIG. 5C from network device C to network device A is replaced with a message 559 from network device A to network device C. Similarly, the message 554 of FIG. 5C from network device G to network device C is replaced with a message 558 from network device C to network device D. In this way, responsive to receiving information from a user input, the network device G stores the information and sends the message 553 containing the information to network device A. Responsive to receiving the message 553, the network device A stores the information contained in the message 553 and then the information is distributed in a top-down way along the tree-like structure 560 from the first level to the second level, and progressively to the third and fourth levels. In the example of FIG. 5D upon receiving the message 558, the network device G need not store the information contained in message 558 and simply sends messages 557 containing the information. In particular, in the example the message 558 contains an identifier of the origination source of the information, the originating source being network device G. The identifier is used by the network device G to determine whether the information needs to be stored and since the information originates from network device G it need not be stored. In another implementation, the message 558 contains a version identifier and the network device G determines whether the information needs to be stored using the version identifier. In yet another implementation each one of network devices A, B, C, D, E, F determines whether the information needs to be sent before sending the information. For example, in one implementation message 559 contains an identifier of network device G as the originating source, and network device C determines that network device G need not receive the information. In such a case message 558 is not sent but nonetheless the network device G sends its respective messages 557.

The cascade method and the multicast method are useful in small systems where there are few network devices and where few messages are required to update the network devices. However, when there are many network devices to be updated preferably the hierarchical method is employed.

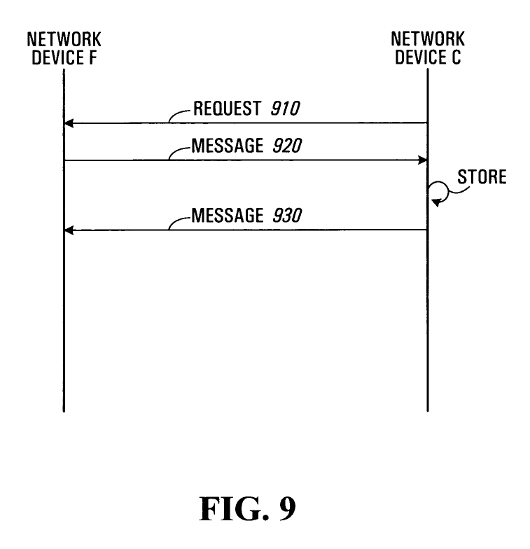

Referring back to FIG. 5C each one of network devices A, B, C, D, E, F, G can detect when another network device becomes available or unavailable. This is achieved for example by having each network device A, B, C, D, E, F, G periodically multicast or broadcast its availability to the other network devices, and a particular network device is detected as being unavailable if a message is not received from the particular network device within a pre-determined period of time. When a network device becomes once again available after being unavailable, the network device and other network devices in a network each determine a new mapping for distribution of information on the basis of the availability of network devices within the network, and information maintained at the network devices is synchronized between the network devices. A method of synchronizing information will now be described with reference to FIGS. 5C and 9.

Referring to FIG. 9, shown is a signal flow diagram between network devices G and C of FIG. 5C for synchronizing information at the network devices G and C. In particular, the signal flow diagram of FIG. 9 is used in the context of an example case scenario in which network device C of FIG. 5C became unavailable and has once again become available. Prior to network device C becoming unavailable, information is distributed in accordance with a mapping defined by the structure 560 of FIG. 5C. When network device C becomes unavailable each network device A, B, D, E, F, G makes use of a different mapping in accordance with another tree-like structure (not shown) that does not include network device C. When network device C becomes once again available, it announces its availability to network devices A, B, D, E, F, G by way of multicast or broadcast messaging for example. The network device C also determines a mapping for distribution of information on the basis of the availability of network devices A, B, C, D, E, F, G, which is illustrated by the structure 560 of FIG. 5C. The network devices A, B, D, E, F, G also update their mapping for information distribution in accordance to the structure 560, which includes network device C. After being unavailable for a period of time, the network device C must update information it maintains. To do so, the network device C updates its information maintained by communicating with neighbouring network devices in the structure 560 of FIG. 5C. In particular, in the example implementation the network device C communicates with its children in the structure 560, the children corresponding to network devices F, G in this case. In FIG. 9, communication is shown with network device F only. However, it is to be clearly understood that network device C also communicates with network device G. In FIG. 9, the network device C sends a request 910 to network device F requesting any new information for which there have been changes made while network device C was unavailable. In particular, the request 910 contains a version identifier for each type of information being maintained. Alternatively, in some implementations there is only one version identifier for all types of information. As discussed above, the version identifier is a sequence number or a timestamp for example. Responsive to receiving the request 910, for each type of information the network device F determines whether information is to be sent to network device C on the basis of the version identifier in the message 910 and a respective version identifier at the network device F. The network device F then sends a message 920 to network device C containing new information and a new version identifier for each type of information that needs an update. Responsive to receiving, the message 920 network device C stores the new information together with the new version identifier, and acknowledges receipt of the new information and the new version identifier(s) with a message 930.

The signaling sequence of FIG. 9 provides a method of updating information at the network device C using the network device F. As will be discussed in further detail below it is possible that information at network device C was changed while it was unavailable to network device F. Furthermore, any new information at network device C must also be updated at network devices A, B, D, E, G. To so, when the network device C becomes available, the network devices A, B, D, E, G also each update their respective information maintained by requesting updates.

For example, in one example implementation the network device B of the second level requests an update from network devices D, E of the third level of structure 560, and the network device C of the second level requests an update from network devices F, G of the third level of structure 560. Similarly, the network device A of the first level requests an update from network devices B, C of the second level of structure 560. However, the network devices B, C wait until they have received updates from network devices D, E, F, G before sending any updates to network device A. In this way, information for updates is propagated up along the structure 560. After information has been propagated up along the structure 560, the network device A, which is at the root of structure 560, determines whether it has information that needs to be transmitted to other network devices by comparing its version identifiers with respective version identifiers received from network devices B, C. In the case that there is information to be transmitted the network device A send the information to network devices B, C, for propagation to the other network devices B, C, D, E, F, G down the structure 560.

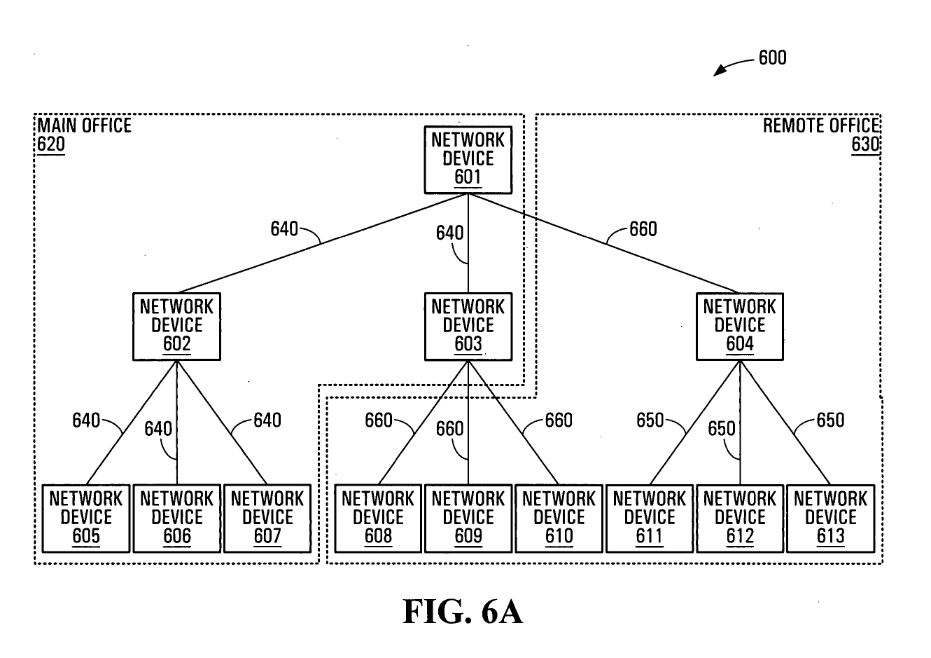

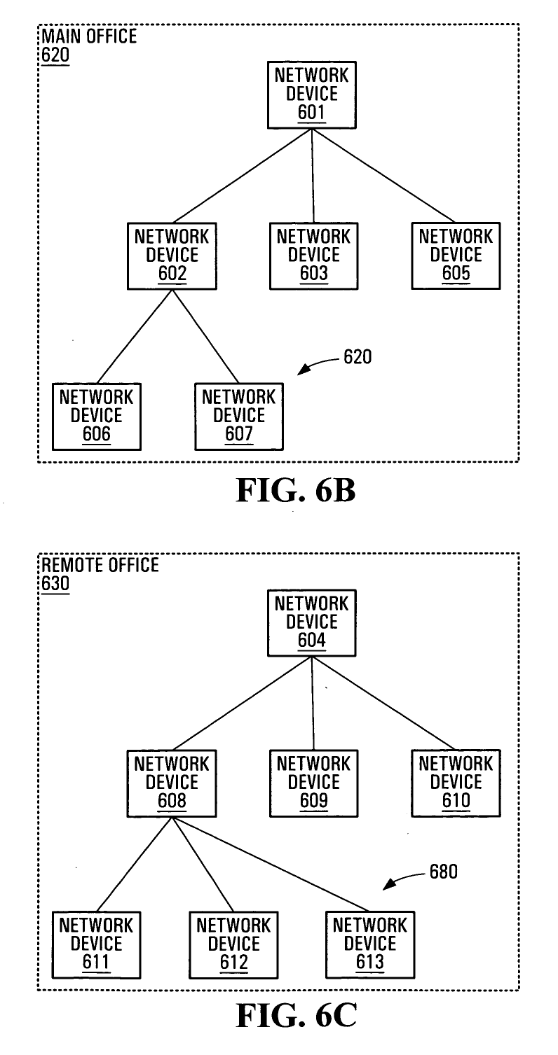

As discussed above, when a network device on a network becomes unavailable, the remaining network devices on the network construct a new mapping for distributing information. An example implementation of how a new mapping can be constructed when a failure occurs will now be described with reference to FIGS. 6A, 6B, and 6C.

Referring to FIG. 6A, shown is a block diagram of network devices arranged in a tree-like structure. In particular, network devices 601, 602, 603, 604, 605, 606, 607, 608, 609, 610, 611, 612, 613 are arranged in a tree-like structure, generally indicated by 600, which defines a mapping for distributing information using the hierarchical method. Network devices 601, 602, 603, 605, 606, 607 are located at a main office 620 whereas network 604, 608, 609, 610, 611, 612, 613 are located at a remote office 630. Within the main office 620, the network devices 601, 602, 603, 605, 606, 607 distribute information by way of logical links 640. Similarly, within the remote office 630, the network devices 604, 611, 612, 613 distribute information by way of logical links 650. The information is also distributed between network devices 601, 603 of the main office 620 and network devices 604, 608, 609, 610 of the remote office 630 by way of logical links 660. Information is distributed according to the above-described hierarchical method; however, in this example implementation, network devices distribute the information to three other network devices instead of two other network devices. More generally, for the hierarchical method, the information is distributed to two or more other network devices.

Each network device 601, 602, 603, 604, 605, 606, 607, 608, 609, 610, 611, 612, 613 detects whether network devices are available or unavailable, as described above. In one example scenario, a failure occurs and there is no longer any communication between the network devices 601, 602, 603, 605, 606, 607 of the main office 620 and the network devices 604, 608, 609, 610, 611, 612, 613 of the remote office 630. In such a scenario, the network devices 601, 602, 603, 605, 606, 607 of the main office 620 detect that the network devices 604, 608, 609, 610, 611, 612, 613 of the remote office 630 are no longer available. Similarly, the network devices 604, 608, 609, 610, 611, 612, 613 of the remote office 630 detect that the network devices 601, 602, 603, 605, 606, 607 of the main office 620 are no longer available.

After detecting the failure, each network device 601, 602, 603, 605, 606, 607 at the main office 620 builds a new mapping for distribution of information. Such a mapping is represented by a tree-like structure generally indicated by 670 in FIG. 6B. In particular, the structure 670 contains the network devices 601, 602, 603, 605, 606, 607 of the main office 620. During the failure, any new information that is input at any one of the network devices 601, 602, 603, 605, 606, 607 is distributed to other ones of the network devices 601, 602, 603, 605, 606, 607 according the structure 670. Similarly, after detecting the failure, each network device 604, 608, 609, 610, 611, 612, 613 at the remote office 630 builds a new mapping for distribution of information. Such a mapping is represented by a tree-like structure generally indicated by 680 in FIG. 6C. In particular, the structure 680 contains the network devices 604, 608, 609, 610, 611, 612, 613 of the remote office 630. During the failure, any new information that is input at any one of the network devices 604, 608, 609, 610, 611, 612, 613 is distributed to other ones of the network devices 604, 608, 609, 610, 611, 612, 613 according the structure 680.

When communication between the main office 620 and the remote office 630 resumes, each network device 601, 602, 603, 604, 605, 606, 607, 608, 609, 610, 611, 612, 613 detects the presence of the other network devices and determines a new mapping for distribution of information in accordance with the structure 600 of FIG. 6A. A synchronization procedure as described above with reference to FIG. 5C and then proceeds.

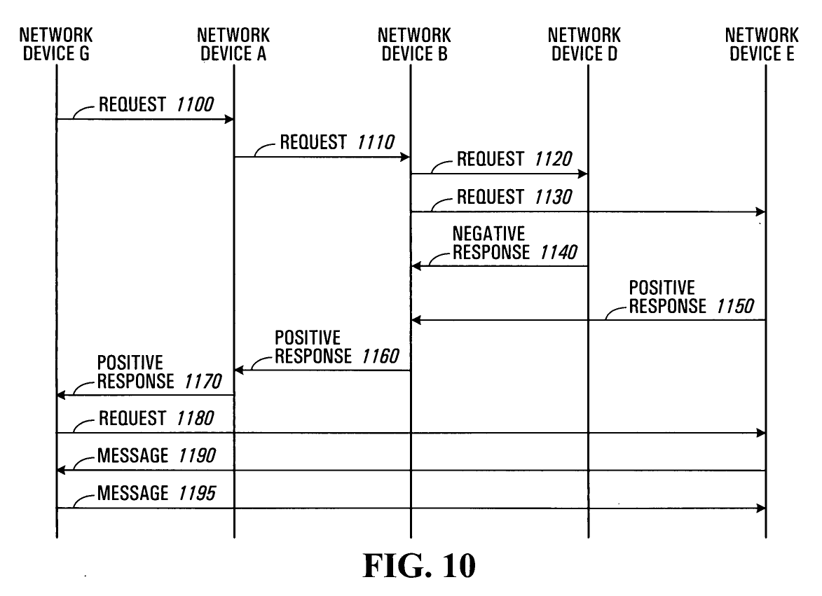

As discussed above a user can perform administrative changes from any one of a plurality of network devices in a network. In some embodiments of the invention a user may be blocked from performing any administrative changes at one of the network devices while another user at another one of network devices is implementing administrative changes. In such embodiments of the invention a network device is provided with exclusive access to a resource for performing administrative changes. An example implementation of such an embodiment will now be described with reference to FIGS. 5C and 10. In the example implementation, only one of the network devices A, B, C, D, E, F, G can allow a user to implement administrative changes at any particular time. In the example implementation, at a particular time the network device E has access to a resource for allowing a user to implement administrative changes; however, a user at network device G wishes to implement administrative changes but network device G does not have access to this resource. To obtain access to the resource, the network device G sends a request 1100 to network device A requesting an identification of the network device that has access to the resource. The network device A forwards this request in the form of a request 1110 to network device B. It is to be clearly understood that the network device A also forwards the request to network device C; however, for purposes of illustrating how the network device G obtains the resource, only the request 1110 to network device B is shown. Responsive to receiving the request 1110, the network device B forwards the request 1110 as requests 1120, 1130 to network devices D, E, respectively. In the example implementation, the requests 1100, 1110, 1120, 1130 contain a identifier of a requester, which corresponds to network device G in this example; a transaction identifier for allowing the network device G to identify the particular request being made; and a data type identifier for identifying the type of information for which the resource is being requested. The data type identifier might be associated with a dialling rule or paging zone definitions for example. The use of data type identifiers allows more than one resource to be used at any one time. For example, a first resource at a network device A might be used to allow user at network device A to implement changes to dialling rules, whereas a second resource at network device B might be used to allow a user at network device B to implement changes to paging definitions.

Referring back to FIG. 10, in this case only network device E has access to the resource, and responsive to receiving the request 1120 the network device D replies to network device B with a negative response 1140 indicating that network device D does not have access to the resource. Responsive to receiving the request 1130, the network device E responds to the network device B with a positive response 1150 indicating that network device E has access to the resource. Responsive to receiving the positive response 1140 and the negative response 1150 from network devices D and E, respectively, the network device B replies to the network device A with a positive response 1160 containing an identifier of network device E for identifying network device E as having access to the resource. Responsive to receiving the positive response 1160, the network device A replies to the network device G with a positive response 1170 containing the identifier of network device E for identifying network device E as having access to the resource. Responsive to receiving the positive response 1170, the network device G sends a request 1180 to network device E requesting that network device E release its access to the resource. Responsive to receiving the request 1180, the network device E determines whether it is currently using the resource and upon verification that the resource is not being used sends a message 1190 to network device G indicating that the resource is being released. Responsive to receiving the message 1190, the network device G replies to the network device E with a message 1195 indicating that it has acquired access to the resource.

It is to be clearly understood that there are many different ways of implementing a method for which only one network device allows administrative changes to be implemented. For example, in another implementation, responsive to receiving requests 1100, 1110, 1120, and 1130, the network devices A, B, C, and D, respectively, respond directly to the network device G with either a positive or negative response.

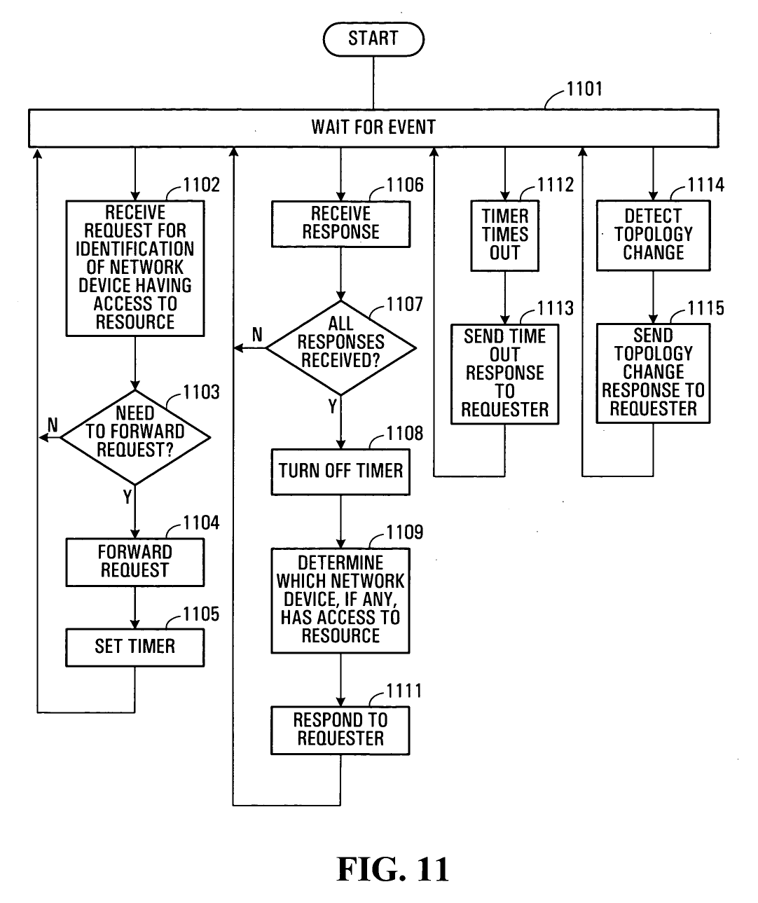

Referring to FIG. 11, shown is a flow chart of a method used by the network devices A, B, C, D, E, F, G of FIG. 5C in locating the resource described above with reference to FIG. 10. At step 1101 a network device waits for an event. At step 1101, the network device receives a request from another network device for identification of the network device that has access to the resource. At step 1103, if the request needs to be forwarded, the request is forwarded to one or more other network devices (step 1104), a timer is set (step 1105), and the network device waits of an event (step 1101); otherwise, the network device simply waits for an event (step 1101). At step 1106, the network device receives a response in response to a request that was sent to another network device. At step 1107, if not all responses have been received, the network device waits for an event (step 1101); however, at step 1107 if all responses have been received the timer is stopped (step 1108). Then at step 1109, the network device determines which of the network device and other network device(s) identified in the response(s), if any, has access to the resource. At step 1109, if no network device has been identified as having access to the resource the network device determines whether it is a root network device, and if it is a root network device it identifies itself as having access to the resource. A root network device is one that is at a top of a tree-like structure. For example, in FIG. 5C, the network device A at the first level corresponds to a root network device for the structure 560. The scenario in which there is no network device identified as having the resource can happen for example when a failure occurs and network devices from different LANs (local area networks) can longer communicate with each other. In such a case, if access to the resource is at a network device of one of the LANs, the network devices on another one of the LANs will not be able to identify the network device having access to the resource while the failure persists.

At step 1111, the network device responds to the requester with an identification of the network device having access to the resource, if any, and then waits for an event (step 1101).

At step 1112, not all expected responses have been received and the timer times out. The network device then sends a timeout response to the requester indicating that not all responses have been received before the timeout.

At step 1114, the network device detects a change in topology of the network in which the network device resides. This might be due to, for example, another network device becoming unavailable. At step 1115, the network device sends a topology change response to the requester indicating that there has been a change in topology. The network device then waits for an event (step 1101).

It is to be clearly understood that the skilled person in the art will understand that the above methods described with reference to FIGS. 10 and 11 in the context of a hierarchical method of distributing information can be clearly applied in the context of the above described cascading and multicasting methods.

Numerous modifications and variations of the present invention are possible in light of the above teachings. It is therefore to be understood that within the scope of the appended claims, the invention may be practised otherwise than as specifically described herein.

We claim:

1. A method comprising:
at a network device, receiving information;
storing the information;
sending the information to at least one other network device; and
using the information at the network device to provide local call facilitating functionality.

2. A method according to claim 1 wherein the information is received from a user input at the network device.

3. A method according to claim 1 comprising:
from a plurality of network devices, determining which of the plurality of network devices the network device is to send the information, the plurality of network devices comprising the at least one other network device.

4. A method according to claim 3 wherein the at least one other network device comprises one other network device.

5. A method according to claim 3 wherein the at least one other network device comprises at least two other network devices.

6. A method according to claim 1 wherein the at least one other network device comprises a plurality of other network devices, the method comprising using a multicast message to send the information to the plurality of other network devices.

7. A method according to claim 1 wherein the information comprises at least one of information for a phone list, administration information, and routing information.

8. A method according to claim 1 comprising:
at the network device, providing exclusive access to a resource for performing administrative changes.

9. A method according to claim 8 wherein the providing exclusive access comprises:
sending a request to the at least one other network device requesting an identification of a network device having exclusive access to the resource; and
responsive to receiving a message containing an identifier of the network device having exclusive access to the resource, sending a message requesting the exclusive access to the resource to the network device having access to the resource.

10. A method according to claim 1 wherein the information is received from another network device other than the network device.

11. A method according to claim 1 wherein the local call facilitating functionality comprises at least one of voice mail, call forward, call transfer, call park and call park pick, back-up services, paging, directory services, and administrative services.

12. A method according to claim 1 wherein each one of the network device and the at least one other network device is one of a terminal set, a packet based telephone, a video phone, a PC (Personal Computer), a PDA (Personal Digital Assistant), a soft phone, a wireless device, a wireless telephone, and a gateway device.

13. A method according to claim 1 wherein each one of the network device and the at least one other network device is a VOIP (Voice over Internet Protocol) telephone.

14. A network device comprising:
an interface adapted to receive information;
a memory for storing the information; and
a processor adapted to:
provide first instructions for sending the information to at least one other network device; and
use the information to provide second instructions for providing local call facilitating functionality.

15. A network device according to claim 14 wherein the interface is a user interface adapted to receive the information from a user input.

16. A network device according to claim 14 wherein the processor is adapted to:
from a plurality of network devices, determine which of the plurality of network devices the network devices is to send the information, the plurality of network devices comprising the at least one other network device.

17. A network device according to claim 16 wherein the at least one other network device comprises one other network device.

18. A network device according to claim 16 wherein the at least one other network device comprises at least two other network devices.

19. A network device according to claim 14 wherein the at least one other network device comprises a plurality of other network devices, the processor being adapted to provide the first instructions for sending the information to the plurality of other network devices using a multicast message.

20. A network device according to claim 14 wherein the information comprises at least one of information for a phone list, administration information, and routing information.

21. A network device according to claim 14 wherein the processor is adapted to:
provide third instructions for providing exclusive access to a resource for performing administrative changes.

22. A network device according to claim 21 wherein to provide the exclusive access to the resource the processor is adapted to:
provide fourth instructions for sending a request to the at least one other network device requesting an identification of a network device having exclusive access to the resource; and
responsive to receiving an identifier of the network device having exclusive access to the resource, providing fifth instructions for sending a message requesting the exclusive access to the resource to the network device having exclusive access to the resource.

23. A network device according to claim 14 wherein the information is received from another network device other than the network device.

24. A network device according to claim 14 wherein the local call facilitating functionality comprises at least one of voice mail, call forward, call transfer, call park and call park pick, back-up services, paging, directory services, and administrative services.

25. A network device according to claim 14 wherein one of the at least one call facilitating functionality is a directory service, the network device comprising:
a user interface adapted to receive a user input requesting the directory service and display associated information associated with the directory service requested,
wherein the memory is adapted to store the associated information, and
wherein responsive to the user input, the processor is adapted to obtain the associated information and provide third instructions to the user interface for displaying the associated information.

26. A network device according to claim 14 wherein one of the at least one call facilitating functionality is an administrative service, the network device comprising:
a user interface adapted to receive a user input comprising the information, the information being associated with the administrative service.

27. A network device according to claim 14 wherein each one of the network device and the at least one other network device is one of a terminal set, a packet based telephone, a video phone, a PC (Personal Computer), a PDA (Personal Digital Assistant), a soft phone, a wireless device, a wireless telephone, and a gateway device.

28. A network device according to claim 14 wherein each one of the network device and the at least one other network device is a VOIP (Voice over Internet Protocol) telephone.

29. A system comprising a plurality of network devices, each network device comprising:
an interface adapted to receive information;
a memory for storing the information; and
a processor adapted to:
provide first instructions for sending the information to at least one respective other network device; and
use the information to provide second instructions for providing local call facilitating functionality,
wherein the at least one respective other network device of each network device collectively comprise all of the plurality of network devices to allow the information to be distributed to all of the plurality of network devices.

30. A system according to claim 29 comprising a gateway device as one of the plurality of network devices.

31. A system according to claim 29 wherein the at least one respective other network device comprises one respective other network device.

32. A system according to claim 29 wherein for each network device the at least one respective other network device comprises all of the plurality of network devices other than the network device.

33. A system according to claim 29 wherein for each network device the at least one respective other network device comprises at least two other network devices.

34. An article of manufacture comprising:
a computer usable medium having computer readable program code means embodied therein, the computer readable code means in said article of manufacture comprising:
computer readable code means for, at a network device, receiving information;
computer readable code means for storing the information;
computer readable code means for providing first instructions for sending the information to at least one other network device; and
computer readable code means for using the information to provide second instructions for providing local call facilitating functionality.

35. An article of manufacture according to claim 34 wherein the information is received from a user input at the network device.

36. An article of manufacture according to claim 34 comprising computer readable code means for:
from a plurality of network devices, determining which of the plurality of network devices the network device is to send the information, the plurality of network devices comprising the at least one other network device.

37. An article of manufacture according to claim 36 wherein the at least one other network device comprises one other network device.

38. An article of manufacture according to claim 36 wherein the at least one other network device comprises at least two other network devices.

39. An article of manufacture according to claim 34 wherein the at least one other network device comprises a plurality of other network devices, the article of manufacture comprising computer readable code means for providing the first instructions for sending the information to the plurality of other network devices using a multicast message.

40. An article of manufacture according to claim 34 wherein the information comprises at least one of information for a phone list, administration information, and routing information.

41. An article of manufacture according to claim 34 comprising computer readable code means for:
providing third instructions for providing exclusive access to a resource for performing administrative changes.

42. An article of manufacture according to claim 41 comprising:
computer readable code means for providing fourth instructions for sending a request to the at least one other network device requesting an identification of a network device having exclusive access to the resource; and
computer readable code means for responsive to receiving an identifier of the network device having exclusive access to the resource, providing fifth instructions for sending a message requesting exclusive access to the resource to the network device having exclusive access to the resource.

43. An article of manufacture according to claim 34 wherein the information is received from another network device other than the network device.

44. An article of manufacture according to claim 34 wherein the local call facilitating functionality comprises at least one of voice mail, call forward, call transfer, call park and call park pick, back-up services, paging, directory services, and administrative services.

45. An article of manufacture according to claim 34 wherein each one of the network device and the at least one other network device is one of a terminal set, a packet based telephone, a video phone, a PC (Personal Computer), a PDA (Personal Digital Assistant), a soft phone, a wireless device, a wireless telephone, and a gateway device.

46. An article of manufacture according to claim 34 wherein each one of the network device and the at least one other network device is a VOIP (Voice over Internet Protocol) telephone.
